(19) United States
(12) Patent Application Publication
(10) Pub. No.: US 2012/0001534 A1
(43) Pub. Date: Jan. 5, 2012

(54) FLAT PANEL DISPLAY DEVICE AND METHOD OF MANUFACTURING THE SAME

(76) Inventor: Tae-Woong Kim, Yongin-city (KR)

(21) Appl. No.: 13/038,273

(22) Filed: Mar. 1, 2011

(30) Foreign Application Priority Data
Jul. 5, 2010 (KR) 10-2010-0064393

(51) Int. Cl. H01J 5/00; H01J 9/26

(52) U.S. Cl. 313/317; 445/25

(57) ABSTRACT

Provided are a flat panel display device having a sealing structure with improved flexibility and a method of manufacturing the flat panel display device. The method includes preparing a first substrate comprising a first polyimide layer, a first barrier layer, and a display unit are sequentially stacked on a first glass substrate; preparing a second substrate comprising a second polyimide layer and a second barrier layer are stacked on a second glass substrate; adhering the first substrate and the second substrate to each other, such that the first barrier layer faces the second barrier layer; and separating the first glass substrate and second glass substrate from the first polyimide layer and second polyimide layer, respectively, by irradiating light thereto.

### CROSS-REFERENCE TO RELATED PATENT APPLICATION

This application claims priority to and the benefit of Korean Patent Application No. 10-2010-0064393, filed on Jul. 5, 2010, in the Korean Intellectual Property Office, the disclosure of which is incorporated herein in its entirety by reference.

### BACKGROUND

1. Field

Embodiments of the present invention relate to a flat panel display device and a method of manufacturing the same.

2. Description of the Related Art

A flat panel display device, e.g., an organic light emitting display device, may be thin and flexible due to its operation properties, and thus various researches are being conducted thereon.

However, in the organic light emitting display device, a display unit may deteriorate due to permeation of moisture. Therefore, the organic light emitting display device requires a structure for sealing and protecting a display unit to prevent permeation of moisture from outside.

Conventionally, a sealing structure, which is formed of glass, for covering a glass substrate on which a display unit is formed and for sealing the gap between the glass substrate and the sealing substrate by using a sealant is generally employed. In other words, a sealant, such as an ultraviolet (UV) ray hardener, is disposed around the display unit on the glass substrate, the sealing substrate is disposed over the structure, and UV rays are irradiated to the sealant, so that the structure is sealed.

However, it is difficult for such a general sealing structure to provide flexible bending characteristics for recent flat panel display devices. Recently, flexible bending characteristics are becoming desirable for some flat panel display devices, such that the flat panel display devices are bent when installed.

### SUMMARY

Embodiments of the present invention provide a flat panel display device having a sealing structure with improved flexibility and a method of manufacturing the flat panel display device.

According to an aspect of an embodiment according to the present invention, there is provided a method of manufacturing a flat panel display device, the method including preparing a first substrate comprising a first polyimide layer, a first barrier layer, and a display unit that are sequentially stacked on a first glass substrate; preparing a second substrate comprising a second polyimide layer and a second barrier layer that are stacked on a second glass substrate; adhering the first substrate and the second substrate to each other, such that the first barrier layer faces the second barrier layer; and separating the first glass substrate and the second glass substrate from the first polyimide layer and the second polyimide layer, respectively, by irradiating light thereto.

The step of adhering the first substrate and the second substrate to each other may include interposing a sealant between the first substrate and the second substrate; and hardening the sealant with light.

The first polyimide layer and the second polyimide layer may be spin coated on the first glass substrate and the second glass substrate, respectively, or may be attached onto the first glass substrate and the second glass substrate as adhesive films, respectively.

The first polyimide layer may have a glass transition temperature above 500° C., and may be formed by polymerizing elements including biphenyl-tetracarboxylic acid dianhydride (BPDA) (3,3′,4,4′-Biphenyl tetracarboxylic Dianhydride) and p-phenylenediamine (PDA).

The second polyimide layer may have a glass transition temperature above 350° C. and is a transparent layer, and may be formed by polymerizing elements including trans-1,4-cyclohexanediamine (CHDA), pyromellitic dianhydride (PMDA), 1,2,3,4-cyclobutane tetracarboxylic dianhydride (CBDA), and hexamethylphosphoramide (HMPA).

The first polyimide layer and the second polyimide layer may each have thicknesses between about 1 μm and about 10 μm.

The first barrier layer and the second barrier layer may include SiO/SiN multi-layer structures and may have water vapor transmission rates below 10⁻⁵ g/m²·day.

The first barrier layer and the second barrier layer may be deposited on the first polyimide layer and the second polyimide layer, respectively.

According to another aspect of the present invention, there is provided a flat panel display device including a first substrate including a first barrier layer and a display unit that are sequentially stacked on a first polyimide layer; and a second substrate including a second polyimide layer on a second barrier layer, wherein the first substrate and the second substrate are joined to each other, such that the first barrier layer and the second barrier layer face each other.

The first polyimide layer may have a glass transition temperature above 500° C., and may be formed by polymerizing elements including biphenyl-tetracarboxylic acid dianhydride (BPDA) (3,3′,4,4′-Biphenyl tetracarboxylic Dianhydride) and p-phenylenediamine (PDA).

The second polyimide layer may have a glass transition temperature above 350° C. and is transparent, and may be formed by polymerizing elements including trans-1,4-cyclohexanediamine (CHDA), pyromellitic dianhydride (PMDA), 1,2,3,4-cyclobutane tetracarboxylic dianhydride (CBDA), and hexamethylphosphoramide (HMPA).

The first polyimide layer and the second polyimide layer may have thicknesses between about 1 μm and about 10 μm.

The first barrier layer and the second barrier layer each may include SiO/SiN multi-layer structures and may have water vapor transmission rates below 10⁻⁵ g/m²·day.

### BRIEF DESCRIPTION OF THE DRAWINGS

The above and other features and advantages of the present invention will become more apparent by describing in detail exemplary embodiments thereof with reference to the attached drawings in which:

FIG. 1 is a cross-sectional view of a flat panel display device according to an embodiment of the present invention; and

FIGS. 2A through 2E are diagrams showing a method of manufacturing the flay panel display device shown in FIG. 1 according to one embodiment of the present invention.

### DETAILED DESCRIPTION

Hereinafter, embodiments of the present invention will be described in detail by explaining embodiments of the invention with reference to the attached drawings.

For a flat panel display device to have flexible bending characteristics, it is desirable to form a sealing structure with a smaller thickness than the generally-used sealing structure.

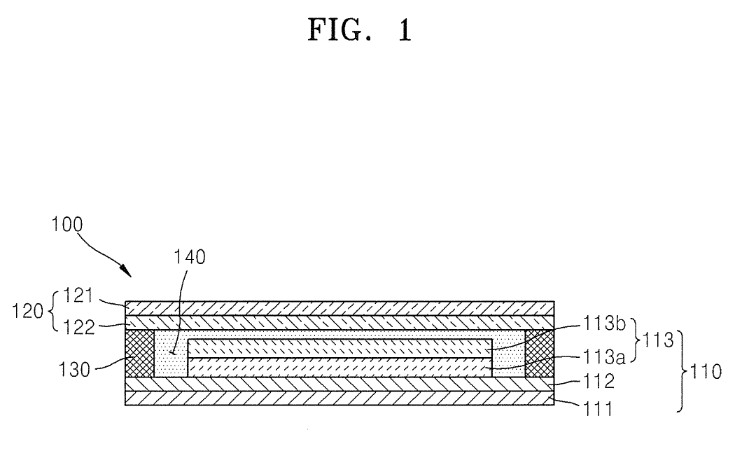

FIG. 1 is a cross-sectional view of a flat panel display device 100 according to an embodiment of the present invention.

Referring to FIG. 1, the flat panel display device 100 is a top-emission type flat panel display device.

The flat panel display device 100 includes a first substrate 110 in which a first barrier layer 112, and a display unit 113 are sequentially stacked on a first polyimide layer 111 in the order stated, a second substrate 120 including a second polyimide layer 121 is stacked on a second barrier layer 122, and a sealant 130 between the first substrate 110 and the second substrate 120. In other words, instead of a glass substrate as in the related art, the display unit 113 is sealed by using a thin-film layer including the first and second polyimide layers 111 and 121 and the first and second barrier layers 112 and 122 in the present embodiment.

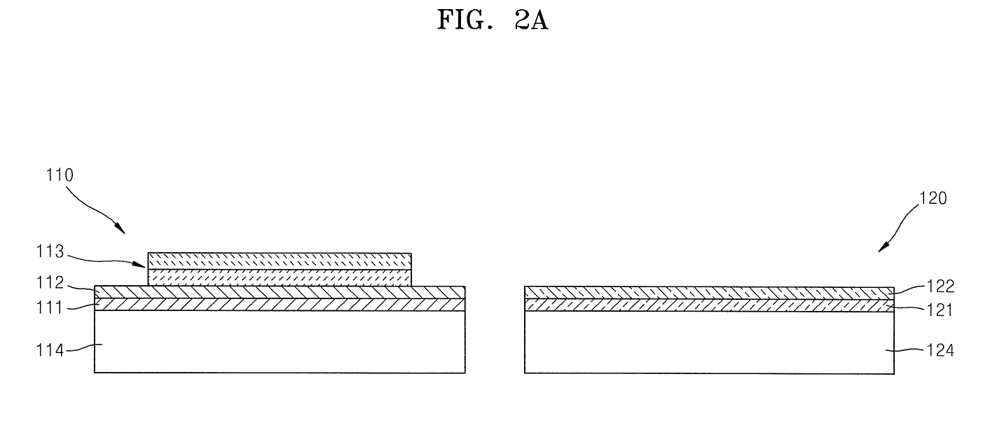

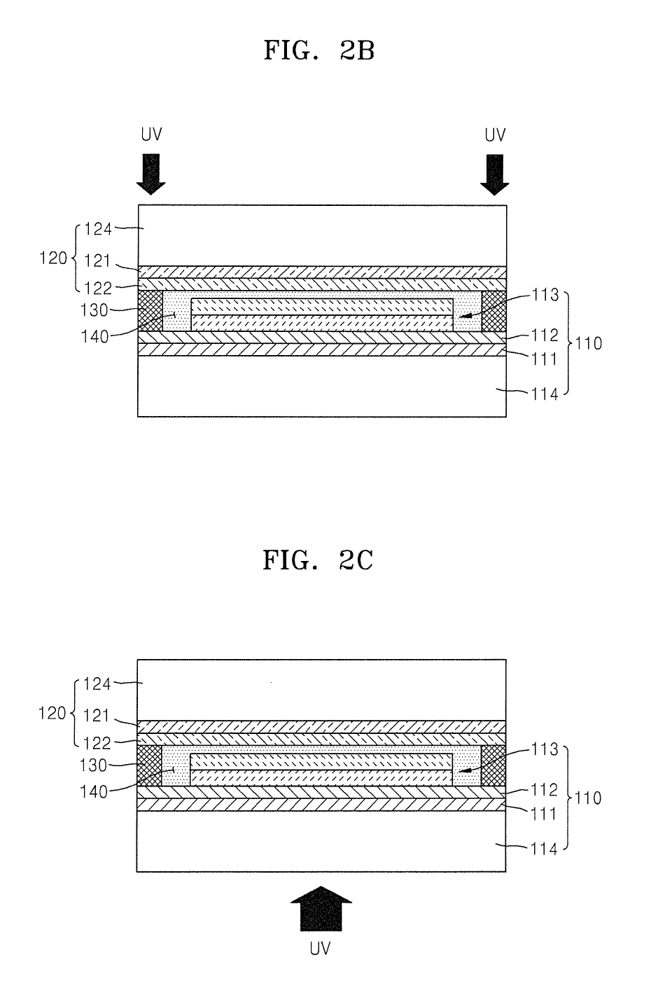

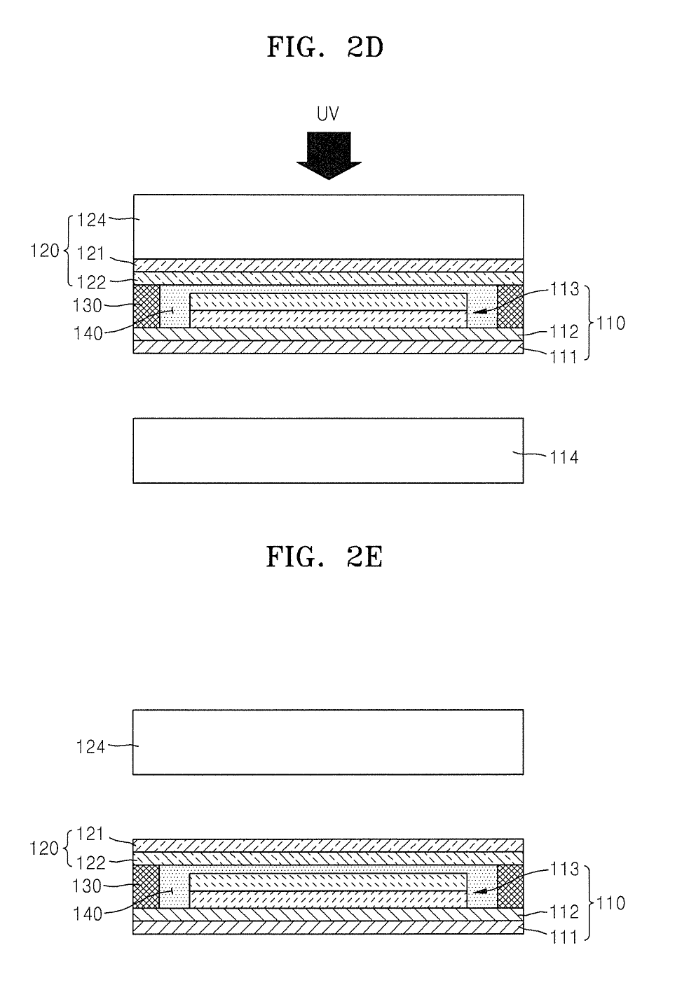

First, the first polyimide layer 111 of the first substrate 110 is formed of thermostable polyimide with a glass transition temperature above 500° C., and may be formed by polymerizing elements including biphenyl-tetracarboxylic acid dianhydride (BPDA) (3,3′,4,4′-Biphenyl tetracarboxylic Dianhydride) and p-phenylenediamine (PDA). Because the display unit 113 is stacked in the first substrate 110 and is patterned by being exposed to light for a plurality of times, the first polyimide layer 111 may also be formed of polyimide with high thermal resistance to prevent deterioration the first polyimide layer 111 during the patterning operation. The first polyimide layer 111 may either be spin coated on a first glass substrate 114 (refer to FIG. 2A) or be attached on the first glass substrate 114 as an adhesive film. The thickness of the first polyimide layer 111 may be from about 1 μm to about 10 μm. Furthermore, the first glass substrate 114 is later separated from the first polyimide layer 111. Therefore, as a result, the first polyimide layer 111 becomes a lower substrate substituting a glass substrate in the related art, and thus the first polyimide layer 111 becomes a highly flexible thin-film substrate having a thickness from about 1 μm to about 10 μm. The process of manufacturing the same will be described below.

Next, the first barrier layer 112, which is stacked on the first polyimide layer 111, is a moisture repellant layer for blocking or reducing permeation of moisture from outside, and may be formed of a SiO/SiN multi-layer structure, for example. The SiO/SiN multi-layer structure is formed by stacking a SiO layer on a SiN layer and has a water vapor transmission rate below 10⁻⁵ g/m²·day. In other words, the SiO/SiN multi-layer structure exhibits excellent moisture repellence. The first barrier layer 112 may be deposited on the first polyimide layer 111.

Furthermore, the display unit 113 is an image-forming layer including a thin-film transistor layer 113a and a light-emitting layer 113b. Because the light-emitting layer 113b is highly vulnerable to moisture, in one embodiment, the display unit 113 is tightly sealed.

As described above, in the first substrate 110, the first barrier layer 112 and the display unit 113 are sequentially stacked on the first polyimide layer 111, whereas, according to one embodiment, the second substrate 120 to be attached to the first substrate 110 has a structure as described below.

First, the second polyimide layer 121 of the second substrate 120 may be formed of transparent polyimide with a glass transition temperature above 350° C. The transparent polyimide may be one or more polymers of a dianhydride monomer, a diamine monomer, and an amide monomer. For example, the transparent polyimide may be a polymer of the dianhydride monomer and the diamine monomer, or a polymer of the dianhydride monomer and the amide monomer. Unlimited examples of the dianhydride monomer may be pyromellitic dianhydride (PMDA), 1,2,3,4-cyclobutane tetracarboxylic dianhydride (CBDA), etc. An unlimited example of the diamine monomer may be trans-1,4-cyclohexanediamine (CHDA). An unlimited example of the amide monomer may be hexamethylphosphoramide (HMPA). Because the present embodiment provides a top-emission type flat panel display device, an image formed by the display unit 113 may be viewable from (or through) the second substrate 120. Therefore, the second polyimide layer 121 is a transparent layer, so that an image formed by the display unit 113 may be transmitted through the second polyimide layer 121. Here, thermal resistance of a transparent polyimide is slightly lower than that of the non-transparent first polyimide layer 111. However, unlike the first polyimide layer 111, the second polyimide layer 121 does not undergo a patterning process together with the display unit 113, and thus a relatively lower thermal resistance of a transparent polyimide layer is not a significant problem. However, because the second polyimide layer 121 undergoes exposure to UV rays during melting-adherence of the sealant 130 for adhering the first and second substrates 110 and 120 to each other and separation of a second glass substrate 124, in one embodiment, the second polyimide layer 121 has a glass transition temperature above 350° C. to prevent or reduce damage. In other words, in one embodiment of the present invention, although the second polyimide layer 121 has a relatively low glass transition temperature as compared to the first polyimide layer 111, the second polyimide layer 121 is still a thermostable layer capable of withstanding heat up to 350° C.

The second polyimide layer 121 may either be spin coated on the second glass substrate 124 (refer to FIG. 2A) or be attached on the second glass substrate 124 as an adhesive film. The thickness of the second polyimide layer 121 may be from about 1 μm to about 10 μm. Furthermore, the second glass substrate 124 is later separated from the second polyimide layer 121. Therefore, as a result, the second polyimide layer 121 becomes an upper substrate substituting a glass substrate in the related art, and thus the second polyimide layer 121 becomes a highly flexible thin-film substrate having a thickness from about 1 μm to about 10 μm. The process of manufacturing the same will be described below.

Next, the second barrier layer 122, which is stacked on the second polyimide layer 121, is a moisture repellant layer for blocking or reducing permeation of moisture from outside, and may be formed of a SiO/SiN multi-layer structure, for example. The SiO/SiN multi-layer structure is formed by stacking a SiO layer on a SiN layer and has a water vapor transmission rate below 10⁻⁵ g/m₂·day. In other words, the SiO/SiN multi-layer structure exhibits excellent moisture repellence. The second barrier layer 122 may be deposited on the second polyimide layer 121.

The first and second substrates 110 and 120 are adhered to each other by interposing the sealant 130 therebetween, wherein the sealant 130 may be a metal oxide with excellent UV absorbability, such as TiOx or ZnOx, or a hybrid polymer.

A filling 140 is filled in the gap between the first and second substrates 110 and 120.

According to one embodiment of the present invention, the flat panel display device 100 as described above may be manufactured in a method as described below.

First, as shown in FIG. 2A, the first substrate 110 and the second substrate 120 are prepared.

The first substrate 110 is prepared by spin coating the first polyimide layer 111 on the first glass substrate 114, depositing the first barrier layer 112 with moisture repellence thereon, and patterning the display unit 113 thereon.

The second substrate 120 is prepared by spin coating the second polyimide layer 121 on the second glass substrate 124 and depositing the second barrier layer 122 with moisture repellence thereon.

Alternatively, the first and second polyimide layers 111 and 121 may be formed as adhesive tapes and attached to the first and second glass substrates 114 and 124, respectively.

The first substrate 110 and second substrate 120 are adhered to each other by interposing the sealant 130 therebetween, so that the first barrier layer 112 faces the second barrier layer 122. Then, the gap between the first substrate 110 and second substrate 120 may be filled with the filling 140 containing moisture absorbent. After the adherence, the first substrate 110 and the second substrate 120 are melt-adhered to each other by irradiating a UV laser with a wavelength from about 300 nm to about 450 nm to the sealant 130. Here, because the first barrier layer 112 and the second barrier layer 122, which contact the sealant 130, are formed of an oxide-type material, that is, SiO/SiN, the first barrier layer 112 and the second barrier layer 122 are adhered well to the sealant 130, which is formed of a metal oxide, such as TiOx or ZnOx.

After the adherence, a UV laser is irradiated to the entire structure from (or through) the first glass substrate 114 as shown in FIG. 2C. As a result, the first glass substrate 114 and the first polyimide layer 111 are separated from each other due to a significant difference between thermal expansion coefficients of the first polyimide layer 111 and the first glass substrate 114.

Therefore, as shown in FIG. 2D, the first glass substrate 114 is separated from the first polyimide layer 111, and the first polyimide layer 111 remains as a lower substrate. Next, a UV laser is irradiated to the entire structure from (or through) the second glass substrate 124. As a result, the second glass substrate 124 and the second polyimide layer 121 are separated from each other due to a significant difference between thermal expansion coefficients of the second polyimide layer 121 and the second glass substrate 124.

Therefore, as shown in FIG. 2E, the second glass substrate 124 is separated from the second polyimide layer 121, and the second polyimide layer 121 remains as an upper substrate.

As a result, the structure surrounding and sealing the display unit 113 includes the first polyimide layer 111, the second polyimide layer 121, the first barrier layer 112, the second barrier layer 122, and the sealant 130.

Therefore, because the thin-film layers, that is, the first polyimide layer 111 and the second polyimide layer 121, replace hard and thick glass substrates in the related art, the flexibility of the flat panel display device 100 may be significantly improved. Furthermore, because the first barrier layer 112 and second barrier layer 122 are SiO/SiN multi-layer structured with water vapor transmission rates below 10⁻⁵ g/m²·day, the flat panel display device 100 may also have excellent moisture repellence.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of manufacturing a flat panel display device, the method comprising:
preparing a first substrate comprising a first polyimide layer, a first barrier layer, and a display unit are sequentially stacked on a first glass substrate;
preparing a second substrate comprising a second polyimide layer and a second barrier layer that are stacked on a second glass substrate;
adhering the first substrate and the second substrate to each other, such that the first barrier layer faces the second barrier layer; and
separating the first glass substrate and the second glass substrate from the first polyimide layer and the second polyimide layer, respectively, by irradiating light thereto.

2. The method of claim 1, wherein the adhering the first substrate and the second substrate to each other comprises:
interposing a sealant between the first substrate and the second substrate; and
hardening the sealant with light.

3. The method of claim 1, wherein the first polyimide layer and the second polyimide layer are spin coated on the first glass substrate and the second glass substrate, respectively.

4. The method of claim 1, wherein the first polyimide layer and the second polyimide layer are attached onto the first glass substrate and the second glass substrate as adhesive films, respectively.

5. The method of claim 1, wherein the first polyimide layer has a glass transition temperature above 500° C.

6. The method of claim 5, wherein the first polyimide layer is formed by polymerizing elements including biphenyl-tetracarboxylic acid dianhydride (BPDA) (3,3′,4,4′-Biphenyl tetracarboxylic Dianhydride) and p-phenylenediamine (PDA).

7. The method of claim 1, wherein the second polyimide layer has a glass transition temperature above 350° C. and is a transparent layer.

8. The method of claim 7, wherein the second polyimide layer is formed by polymerizing elements including a dianhydride monomer, a diamine monomer, and an amine monomer. trans-1,4-cyclohexanediamine (CHDA), pyromellitic dianhydride (PMDA), 1,2,3,4-cyclobutane tetracarboxylic dianhydride (CBDA), and hexamethylphosphoramide (HMPA).

9. The method of claim 1, wherein the first polyimide layer and the second polyimide layer each have thicknesses between about 1 μm and about 10 μm.

10. The method of claim 1, wherein the first barrier layer and the second barrier layer comprise SiO/SiN multi-layer structures.

11. The method of claim 10, wherein the first barrier layer and the second barrier layer have water vapor transmission rates below 10⁻⁵ g/m²·day.

12. The method of claim 1, wherein the first barrier layer and the second barrier layer are deposited on the first polyimide layer and the second polyimide layer, respectively.

13. A flat panel display device comprising:
a first substrate comprising a first barrier layer and a display unit that are sequentially stacked on a first polyimide layer; and
a second substrate comprising a second polyimide layer on a second barrier layer,
wherein the first substrate and the second substrate are joined to each other, such that the first barrier layer and the second barrier layer face each other.

14. The flat panel display device of claim 13, wherein the first polyimide layer has a glass transition temperature above 500° C.

15. The flat panel display device of claim 14, wherein the first polyimide layer is formed by polymerizing elements including biphenyl-tetracarboxylic acid dianhydride (BPDA) (3,3′,4,4′-Biphenyl tetracarboxylic Dianhydride) and p-phenylenediamine (PDA).

16. The flat panel display device of claim 13, wherein the second polyimide layer has a glass transition temperature above 350° C. and is transparent.

17. The flat panel display device of claim 16, wherein the second polyimide layer is formed by polymerizing elements including a dianhydride monomer, a diamine monomer, and an amine monomer.

18. The flat panel display device of claim 13, wherein the first polyimide layer and the second polyimide layer each have thicknesses between about 1 μm and about 10 μm.

19. The flat panel display device of claim 13, wherein the first barrier layer and the second barrier layer each comprise SiO/SiN multi-layer structures.

20. The flat panel display device of claim 19, wherein the first barrier layer and the second barrier layer have water vapor transmission rates below 10⁻⁵ g/m²·day.
